(19) United States
(12) Patent Application Publication
(10) Pub. No.: US 2012/0138833 A1
(43) Pub. Date: Jun. 7, 2012

(54) Multi-Function Eccentrically Actuated Microvalves and Micropumps

(76) Inventor: Joseph Matteo, Walland, TN (US)

(21) Appl. No.: 12/958,931

(22) Filed: Dec. 2, 2010

(51) Int. Cl. F16K 31/44

(52) U.S. Cl. 251/251

(57) ABSTRACT

Eccentrically actuated microvalves and micropumps. Microfluidic channels are formed in multi-layered laminar assemblies with at least one layer including an elastomeric material. In some embodiments, the microvalves and micropumps are controlled by eccentrically driven actuators, including in some embodiments cam-driven actuators. A cam-driven actuator activates a microvalve by pressing on the elastomeric layer, deforming the elastomeric layer so that it meets a second layer at a location within the channel, thereby either partially or completely obstructing the flow of liquid through the channel at that location, i.e. “pinching” the channel. The actuator is moved into position by a cam, which includes detents that allow the actuator to move away from the first layer or raised areas that force the actuator to move toward the first layer. Some embodiments include multiple microvalves, in which case a single cam, controlled by a single position-control mechanism, is able to control multiple microvalves. The resulting apparatuses are useful for controlling multi-channel microfluidic systems in an energy-efficient and space-efficient manner.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The present invention relates generally to microscale devices for performing analytical testing and, in particular, to valves and pumps for use in microscale chemistry.

2. Description of the Related Art

Mircofluidic devices have in recent years found increased application for performing analytical tasks in a number of fields. Particularly in various chemical, biological, and biomedical disciplines, microfluidic systems allow complicated biochemical reactions to be carried out using very small volumes of liquid and small samples of reagents. In these applications microfluidic devices are often constructed in a multi-layer laminated assembly that defines microscale channels or in structures formed from laminate material. In this context, a microscale channel is generally defined as a fluid passage which has at least one internal cross-sectional dimension that is less than 900 micrometers.

Many types of valves and pumps for use in directing and controlling fluids in microfluidic environments are known in the art. Typical of the art in this field are U.S. Pat. No. 5,899,437, issued on May 4, 1999 to Quarre; U.S. Pat. No. 6,068,751, issued May 30, 2000 to Neukermans; U.S. Pat. No. 6,102,068, issued Aug. 15, 2000 to Higdon et al.; U.S. Pat. No. 6,143,248, issued Nov. 7, 2000 to Kellogg; U.S. Pat. No. 6,581,899, issued Jun. 24, 2003 to Williams; U.S. Pat. No. 6,619,311, issued Sep. 16, 2003 to O'Connor et al.; U.S. Pat. No. 6,626,417, issued Sep. 30, 2003 to Winger et al.; U.S. Pat. No. 6,739,576, issued May 25, 2004 to O'Connor et al.; U.S. Pat. No. 6,748,975, issued Jun. 15, 2004 to Hartshorne et al.; U.S. Pat. No. 6,802,489, issued Oct. 12, 2004 to Marr et al.; U.S. Pat. No. 6,929,030, issued Aug. 16, 2005 to Unger et al.; U.S. Pat. No. 7,144,616, issued Dec. 5, 2006 to Unger et al.; U.S. Pat. No. 7,258,774, issued Aug. 21, 2007 to Chou et al.; and U.S. Pat. No. 7,601,270, issued Oct. 13, 2009 to Unger et al. Also typical of the art in this field are a utility patent application by O'Conner et al., published Oct. 23, 2003 as U.S. Patent Pub. No. 2003/0196695; and a utility patent application by Unger et al., published Jul. 24, 2008 as U.S. Patent Pub. No. 2008/0173365.

### BRIEF SUMMARY OF THE INVENTION

Disclosed are microvalves and micropumps for use with a microfluidic system. In some embodiments, the microvalves and micropumps are controlled by eccentrically driven actuators, including in some embodiments cam-driven actuators. In some embodiments, the microfluidic system includes at least one channel incorporated into a laminar structure. The laminar structure includes at least two layers: a first layer fabricated from an elastomer or similar material, and a second layer fabricated from a material that is either rigid, substantially rigid, flexible, or elastic. The two layers cooperatively define a channel formed by an extended indentation in a surface of the first layer, the second layer, or both layers. One surface of the first layer faces one surface of the second layer, with the channel on at least one of the facing surfaces. The said one surface of the first layer and the said one surface of the second layer largely adhere to one another, with the channel between the two layers through which fluid is able to flow. In some embodiments, the two layers are held together by pressure; in some embodiments, an adhesive substance coats at least part of one or both facing surfaces at the places where the two surfaces touch; in some embodiments, the two surfaces are anodically bonded; in other embodiments, the two surfaces are fused with heat; in still other embodiments, some other surface treatment is used to bond the two layers to each other.

In one embodiment of the present invention, a cam-driven actuator activates a microvalve by pressing on the elastomeric first layer, deforming the first layer so that the first layer and the second layer meet at a location within the channel, thereby either partially or completely obstructing the flow of fluid through the channel at that location (i.e. “pinching” the channel). The actuator is moved into position by a cam, which includes detents that allow the actuator to move away from the first layer or raised areas that force the actuator to move toward the first layer. Although the present invention contemplates many types of cam-driven actuators, in one preferred embodiment the actuator comprises one or more actuator balls, which are displaced by a cam to deform the elastomeric first layer.

Cam-driven pinch-style microvalves are useful for serving as on/off valve devices for a microfluidic system. Additionally, some embodiments of the present invention include one or more of these cam-driven pinch-style microvalves to form multifunction devices, including but not limited to distribution valves, switching valves, peristaltic pumps, and other devices. In some embodiments, two or more of the above devices are combined to work with integrated fluidic circuits.

In some embodiments, the cam is driven and directed by a position-control mechanism, which is electrically powered, hydraulically powered, pneumatically powered, or manually powered, depending on the embodiment. In those embodiments that include multiple microvalves or multifunction devices, the cam-driven microvalves allow a single position-control mechanism, operating in conjunction with a single cam, to control multiple microvalves. The ability to use a single position-control mechanism and a single cam to control multiple microvalves allows for the multi-state positioning of the microvalves with minimal space requirements and minimal control complexity. Further, unlike, for example, flow-control mechanisms that rely on the application of electric currents to cause and sustain physical displacement, cam-driven pinch-style microvalves are capable of generating high compressive forces that do not require additional energy to be sustained. Also, flow-control mechanisms that rely on the application of electric currents to cause electrokinetic flow only function with charged fluids or fluids containing electrolytes; cam-driven pinch-style microvalves and micropumps according to the present invention are usable with a wider variety of fluids.

Cam-driven pinch-style microvalves are useful for controlling multi-channel microfluidic systems with an energy-efficient and space-efficient apparatus. Thus, these microvalves have uses in a number of diverse fields and applications, including medical and scientific instrumentation, remotely controlled machines such as space probes and undersea probes, and portable analytical equipment for use in the field.

### BRIEF DESCRIPTION OF THE DRAWINGS

The above-mentioned features of the invention will become more clearly understood from the following detailed description of the invention read together with the drawings in which:

FIG. 1 is a block diagram representation of one embodiment of the invention;

FIG. 2 is a perspective view of one embodiment of the invention;

FIG. 3 is an exploded view of the embodiment shown in FIG. 2;

FIG. 4A is a top-down view of the embodiment shown in FIG. 2, showing the section line used for the section view shown in FIGS. 5A and 5B;

FIG. 4B is a top-down view of the embodiment shown in FIG. 2, showing the section line used for the section view shown in FIGS. 6A and 6B;

FIG. 5A is a section view of the embodiment shown in FIG. 2, showing the microvalve in an open state;

FIG. 5B is a section view of the embodiment shown in FIG. 2, showing the microvalve in a closed state;

FIG. 6A is a section view of the embodiment shown in FIG. 2, showing the microvalve in an open state;

FIG. 6B is a section view of the embodiment shown in FIG. 2, showing the microvalve in a closed state;

FIG. 7 is a section view of one embodiment of the invention utilizing multiple actuator balls for one microvalve;

FIG. 8 is a perspective view of one embodiment of the invention, showing the use of the invention to operate a distribution valve;

FIG. 9 is a top-down view of the embodiment shown in FIG. 8;

FIG. 10A is a section view of the embodiment shown in FIG. 8, with a first microvalve pinched and a second microvalve other open;

FIG. 10B is a section view of the embodiment shown in FIG. 8, with the first microvalve open and the second microvalve other pinched;

FIG. 10C is a section view of the embodiment shown in FIG. 8, with both microvalves open;

FIG. 11 is a perspective view of one embodiment of the invention, with one cylindrical cam controlling several actuator balls and several microvalves in a microfluidic system;

FIG. 12 is a view of the embodiment shown in FIG. 11, with an inset view of part of the apparatus;

FIG. 13 is a perspective view of one embodiment of the invention with a rotary cam;

FIG. 14 is an exploded view of the embodiment shown in FIG. 13;

FIG. 15 is a perspective view of one embodiment of the invention with a plate cam;

FIG. 16 is an exploded view of the embodiment shown in FIG. 15;

FIG. 17 is a perspective view of one embodiment of the invention, showing a cam-driven peristaltic pump;

FIG. 18 is an exploded view of the embodiment shown in FIG. 17;

FIG. 19 is a top-down view of the embodiment shown in FIGS. 17 and 18, with the second layer removed;

FIG. 20A a top-down view of the embodiment shown in FIGS. 17, 18 and 19, with the first layer and the second layer removed;

FIG. 20B a top-down view of the embodiment shown in FIGS. 17, 18, 19, and 20A, with the first layer and the second layer removed, where the cam has been rotated from the state seen in FIG. 20A;

FIG. 21A is a section view of the embodiment shown in FIGS. 17, 18, 19, 20A, and 20B, showing the cam in the position seen in FIG. 20A; and

FIG. 21B is a section view of the embodiment shown in FIGS. 17, 18, 19, 20A, 20B, and 21A, showing the cam in the position seen in FIG. 20B.

### DETAILED DESCRIPTION OF THE INVENTION

A microfluidic system including a microvalve that uses eccentrically driven actuators to control fluid flow by pinching the channels at selected locations along the length of the channels is described herein with reference to the drawings.

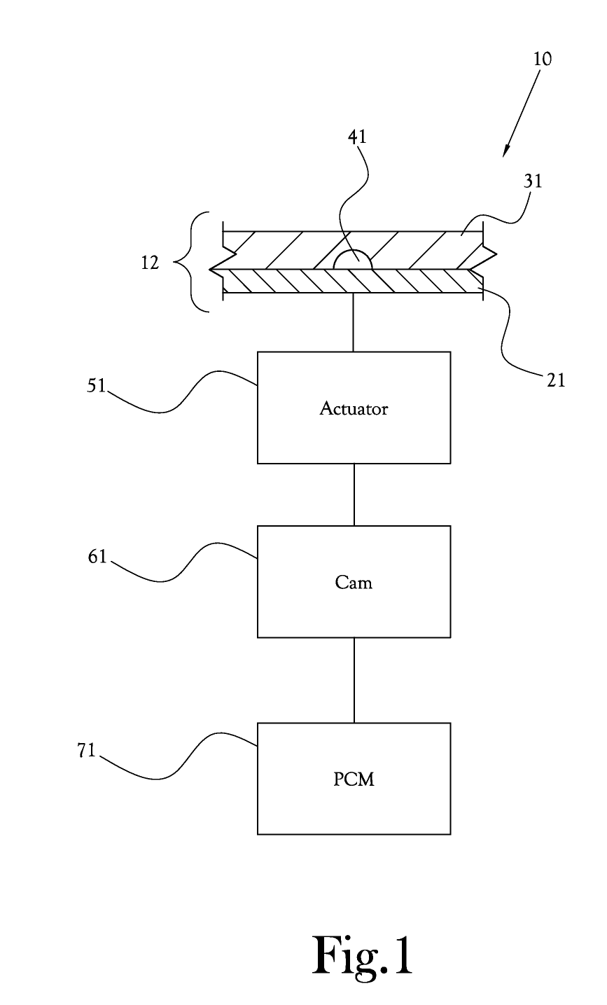

FIG. 1 is a block diagram of one embodiment of a microvalve according to the present invention. The eccentrically actuated, cam-driven microvalve 10 includes a multilayer channel member 12, an actuator 51, a cam 61, and a position-control mechanism (PCM) 71. The multilayer channel member 12 includes a first layer 21, fabricated from an elastomeric material, and a second layer 31, which is either rigid, substantially rigid, flexible, or elastic. The first layer 21 and the second layer 31 cooperate to define at least one channel 41. An actuator 51 works with a cam 61 to pinch the channel 41 and restrict the flow of fluid. The cam 61 is driven by the PCM 71 between a first position and a second position. In the first position, the cam 61 causes the actuator 51 to move in an eccentric motion to press the first layer 21 against the second layer 31 in a substantially fluid-tight fit to substantially close the channel 41. In the second position, the cam 61 does not cause the actuator 51 to engage the first layer 21, allowing the elastomeric first layer 21 to retract from the second layer 31 and allow fluid to flow through the open channel 41. In some embodiments, the cam-driven microvalves include a disposable component, such as an interchangeable multi-layer channel member that may be discarded after one use or multiple uses.

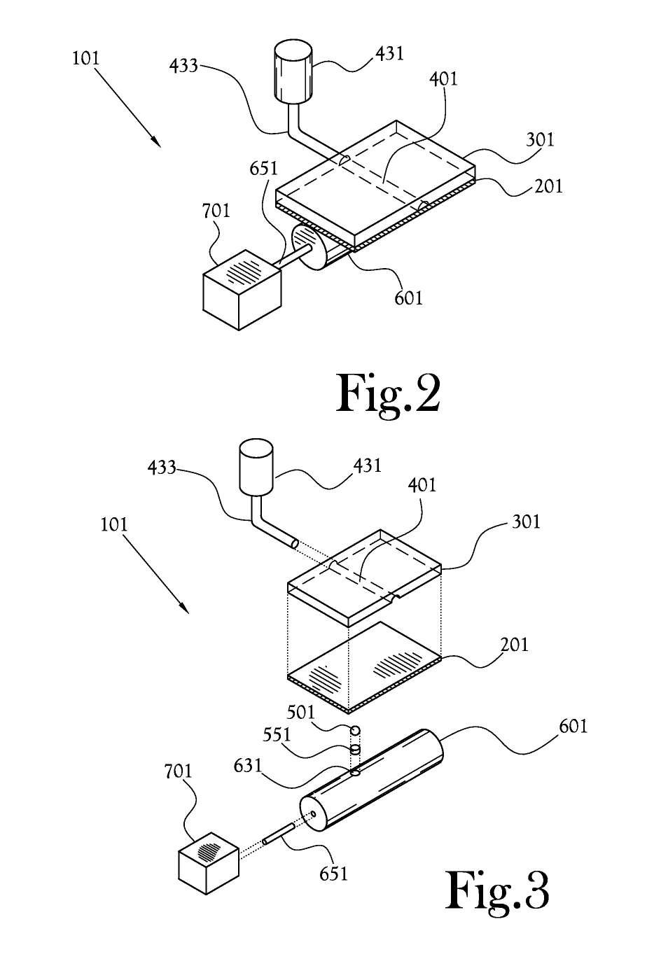

FIG. 2 shows a perspective view of one embodiment of the present invention. The microvalve 101 includes a first layer 201 fabricated from an elastomeric material, and a second layer 301, which is either rigid, substantially rigid, flexible, or elastic. As seen clearly in the exploded view in FIG. 3, a channel 401 has been formed between the first layer 201 and the second layer 301 by forming an extended indentation in the surface of the second layer 301. One of skill in the art will appreciate that various methods exist for manufacturing the channel 401 in the second layer 301, including molding, etching, extruding, milling and other processes. In some embodiments, the second layer 301 is molded, and the shape of the channel 401 is included in the mold; in some embodiments, the channel 401 is carved out of the second layer 301 after that layer 301 has been fabricated. In some embodiments, the channel is formed by manufacturing an extended indentation in the first layer, or in both layers. In various embodiments, the two layers are held together by pressure or by a bonding solution.

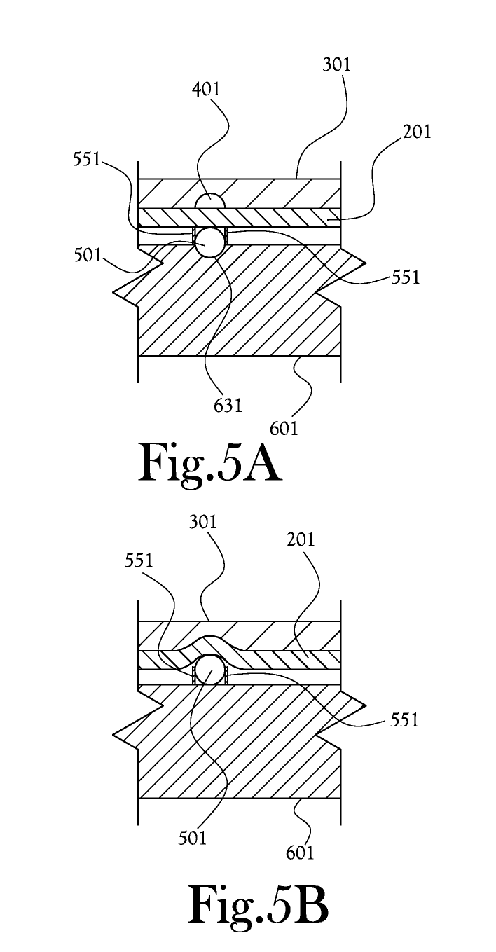

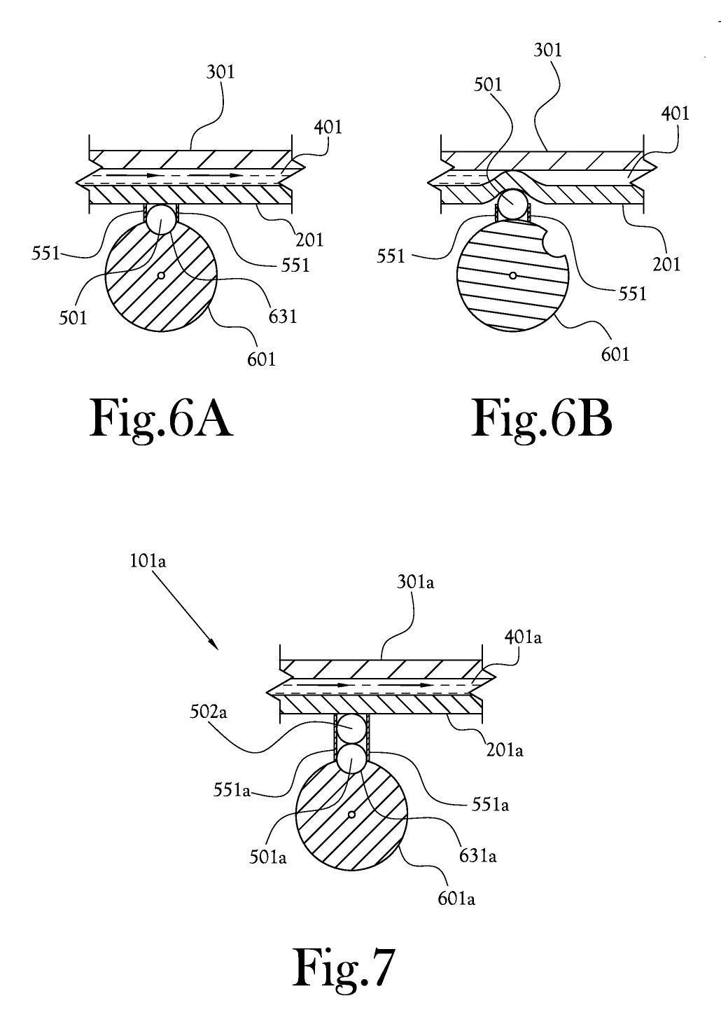

As shown in the exploded view of the embodiment in FIG. 3 and in the sectional views in FIGS. 5A and 6A, a cam 601 is positioned near the first layer 201. Between the cam 601 and the first layer 201 is an actuator ball 501 positioned in close proximity to a place where the channel 401 runs on the other side of the first layer 201. The cam 601 in this embodiment is a cylindrical cam; rotation of the cylinder moves a detent 631 on the cylinder into and out of position under the actuator ball 501. A position-control mechanism (PCM) 701 controls the cam 601 by turning the axle 651, thereby turning the cylindrical cam 601. In various embodiments, the PCM 701 is electrically powered, hydraulically powered, pneumatically powered, or manually powered, depending on the embodiment. In some embodiments, the PCM 701 is a single electric gear motor, which can be turned on and off to rotate the cylindrical cam 601 into the desired position.

A guide tube 551 partially surrounds the actuator ball 501, keeping the actuator ball 501 in place between the cam 601 and the first layer 201 by preventing it from travelling with the detent 631 as the cylinder cam 601 rotates. In some embodiments, the actuator ball is kept in place between the cam and the first layer by a guide plate (i.e., a substantially rigid layer of material between the cam and the elastomeric first layer) defining a guide aperture through which the actuator ball moves closer to and away from the first layer.

When the microvalve 101 is in the open state, as in the sectional views of FIGS. 5A and 6A, fluid flows through the channel 401 from, for instance, a fluid storage container 431 and fluid input tube 433, shown in FIGS. 2 and 3. When the cam 601 is rotated, so that the actuator ball 501 no longer rests in the detent 631 of the cam 601, then the actuator ball 501 moves within the guide tube 551 toward the elastomeric first layer 201, as shown in FIGS. 5B and 6B. With the cam 601 and the actuator ball 501 now in position to effect the closed state of the microvalve 101, the actuator ball 501 pushes on the first layer 201, deforming the elastomeric first layer 201 so that the first layer 201 and the second layer 301 meet within the channel 401, thereby partially or completely stopping the flow of fluid through the channel 401 (i.e., “pinching” the channel).

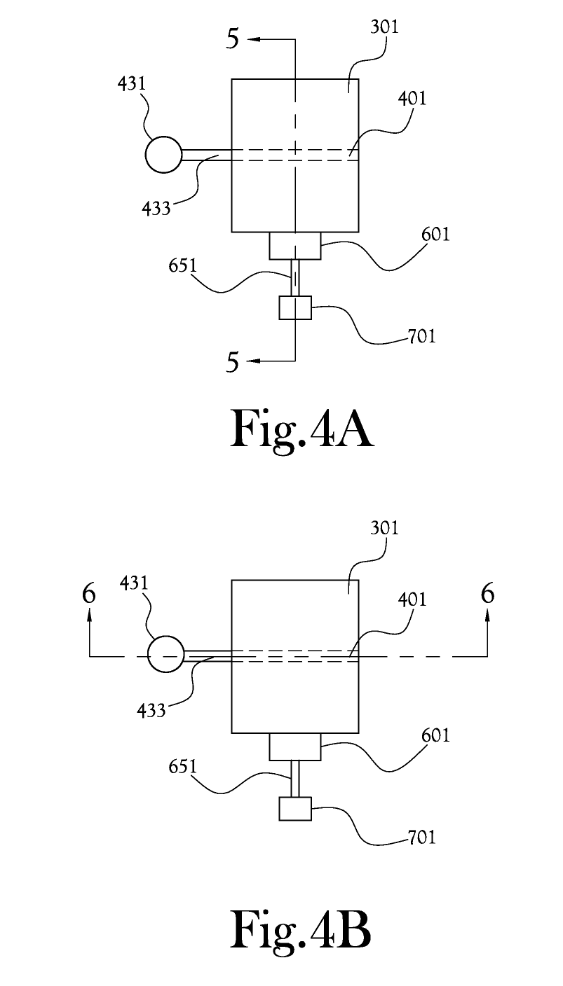

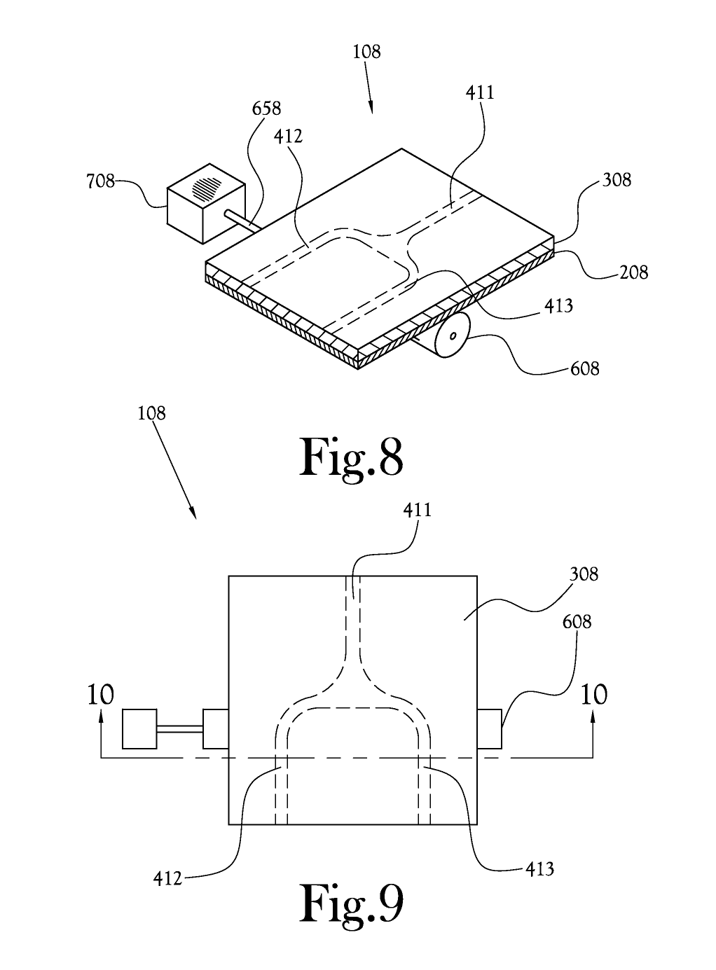

In the embodiment shown in FIGS. 2, 3, 4A, 4B, 5A, 5B, 6A, and 6B, the actuator mechanism (that is, the mechanism that pinches the two layers 201 and 301 together to close the microvalve 101) comprises a single actuator ball 501. However, other arrangements are possible, as in the embodiment shown in FIG. 7, in which the microvalve 101a includes two actuator balls 501a and 502a. Those of skill in the art will recognize that other arrangements exist for connecting the actuator to the first layer, including balls, pins, or linkages; the arrangement used in a specific embodiment often is selected to accommodate specific packaging requirements. Other actuator arrangements are also contemplated by this invention.

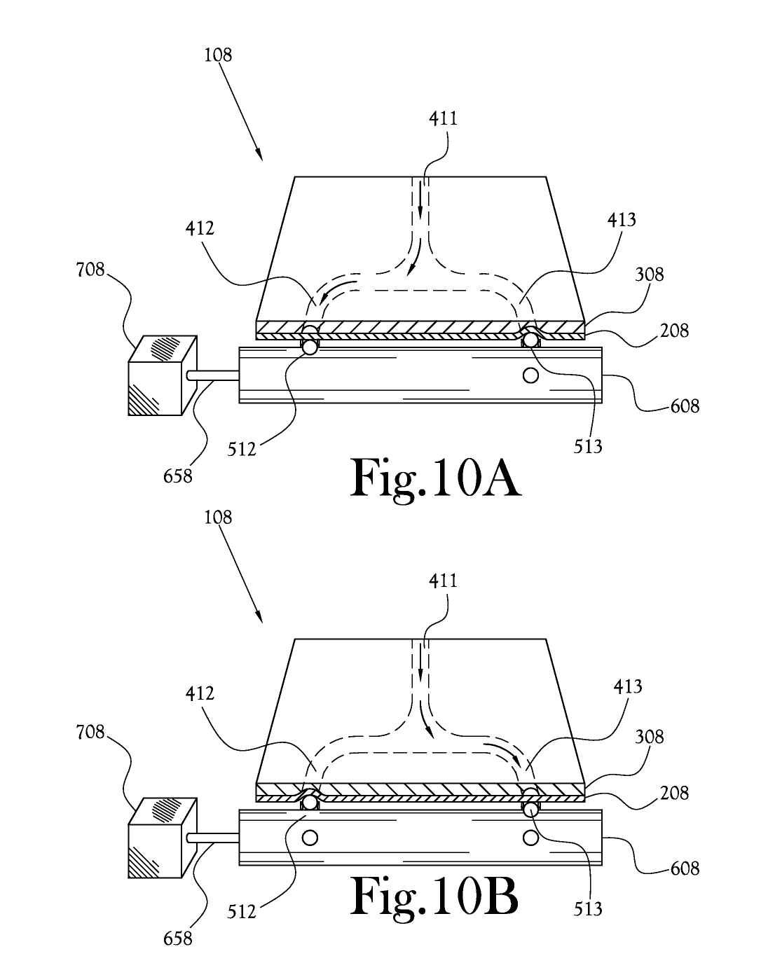

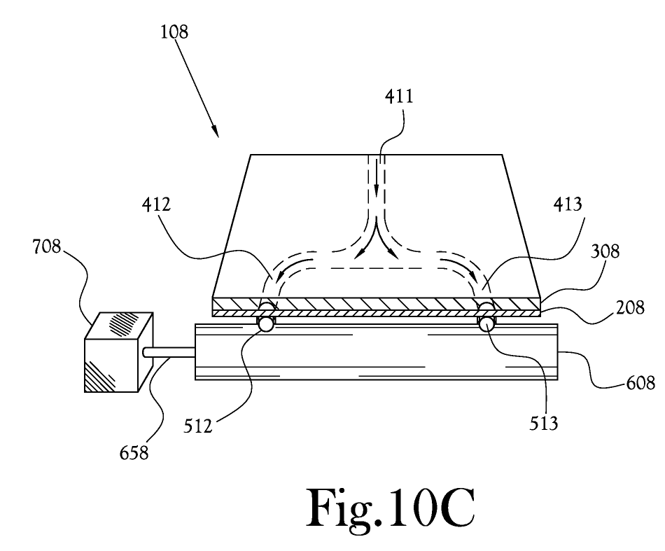

FIG. 8 shows a perspective view of one embodiment of the present invention in which two cam-driven pinch-style microvalves operated by one cam work in coordination to form a two-way distribution valve. FIG. 9 shows a top-down view of the same embodiment. As seen in FIG. 8, the microfluidic system 108 includes a second layer 308 with three connected channels: the input channel 411, the first distribution channel 412, and the second distribution channel 413. As seen in the section view in FIG. 10A, this microfluidic system 108 includes a cylindrical cam 608 and two actuator balls 512 and 513. The actuator ball 512 is positioned to pinch channel 412, and the actuator ball 513 is positioned to pinch channel 413. In this embodiment, the cylindrical cam 608 has a number of detents, which allow for multiple settings of the actuator balls 512 and 513. In the first setting, seen in FIG. 10A, the first actuator ball 512 is resting in a detent, while the second actuator ball 513 is not in a detent and therefore is pinching the second channel 413. With the second channel 413 in the closed state, the fluid from the input channel 411 flows through the first distribution channel 412. In the second setting, seen in FIG. 10B, the cam 608 has been rotated so that now the second actuator ball 513 is resting in a detent, while the first actuator ball 512 is not in a detent and therefore is pinching the first channel 412. With the first channel 412 in the closed state, the fluid from the input channel 411 flows through the second distribution channel 413. Finally, in the third setting, seen in FIG. 10C, the cam 608 has been rotated yet again so that now both actuator balls 512 and 513 are resting in detents, and both distribution channels 412 and 413 are in an open state.

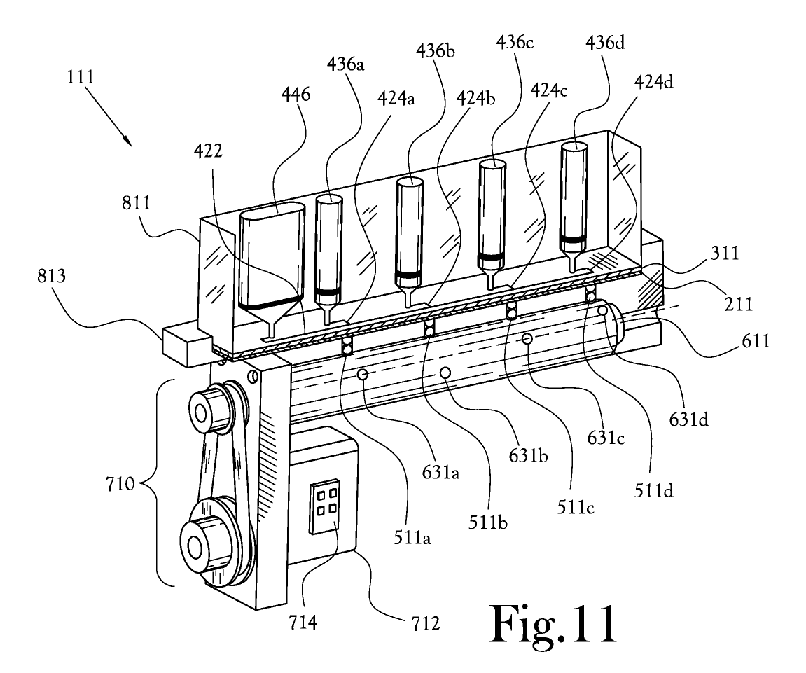

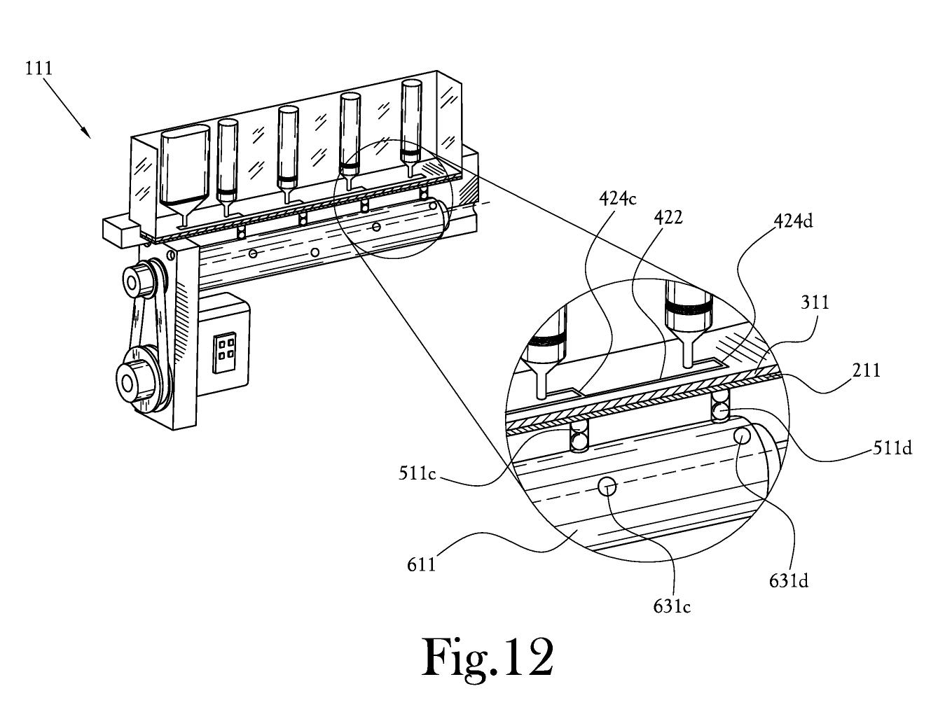

FIG. 11 shows a microfluidic system incorporating a plurality of microvalves according to one embodiment of the present invention. The apparatus 111 includes multiple microvalves that operate to regulate the flow of fluids in a microfluidic system; all of the microvalves are controlled by a single cam 611 adapted to work with multiple actuator balls 511a-d. As shown in FIG. 11, and as shown in the inset in FIG. 12, the apparatus 111 includes a plurality of fluid storage vessels 436a-d. These fluid storage vessels 436a-d are in fluid communication with a mixing vessel 446. A main channel 422 connects the mixing vessel 446 with a number of side channels 424a-d, each side channel 424a-d leading to a fluid storage vessel 436a-d. As in the previously illustrated embodiments, the apparatus 111 includes a first layer 211 and a second layer 311.

The main channel 422 and the side channels 424a-d are carved into the second layer 311 and comprise fluid-passable passages between the first layer 211 and the second layer 311. (It should be noted that, in FIGS. 11 and 12, the second layer 311 is fabricated from a clear plastic or similar material, which allows an observer to see the channels from the exterior of the apparatus. However, in some embodiments of the invention, the channels may not be visible from the outside, depending upon the material from which the second layer is fabricated.)

A cylinder cam 611 with multiple detents, e.g., 631a-d, is positioned below the elastomeric first layer 211. Actuator balls 511a-d are positioned between the cam 611 and the first layer 211. A drive belt 710 connects the cam 611 to a PCM 712, which includes a control pad 714 to allow an operator to direct the PCM 712. In some embodiments, the PCM is a single motor, which spins the drive belt 710 to turn the cylinder cam 611. The various components of the apparatus 111 are held together by a housing 813, which includes guide slots which hold the actuator balls 511a-d in place, and a glass or plastic sub-housing 811 to protect the fluid storage vessels 436a-d and the mixing vessel 446.

As the cam 611 rotates about its central axis, different detents will come into position below certain of the actuator balls, opening the microvalves leading to different fluid storage vessels. The illustrated apparatus 111 allows for a number of settings in with differing combinations of open and closed microvalves. Thus, for example, in the illustrated embodiment, the detents 631a and 631c lie along the same longitudinal line on the cylinder cam 611 (this longitudinal line being shown by a dashed line in FIG. 11). When the cam 611 rotates so that the detents 631a and 631c lie directly under the actuator balls 511a and 511c, respectively, then at that point the actuator balls 511a and 511c will rest in their respective detents and will be exerting minimal pressure on the first layer 211; the side channels 424a and 424c, which are positioned directly above the actuator balls 511a and 511c, respectively, will be open, and fluid will flow from the fluid storage containers 436a and 436c through their respective open side channels and into the main channel 422, where the fluids will proceed to the mixing vessel 446. At the same time, the actuator balls 511b and 511d, which are not resting in detents, will be pushed upward by the cam 611 to exert deformative pressure on the first layer 211 to pinch their respective side channels 424b and 424d. With the channels 424b and 424d pinched, fluid does not flow from the two fluid storage containers 436b and 436d.

The particular combination of open and closed microvalves described in the previous paragraph, which depends upon the cam 611 being in a particular position so that some actuator balls are in detents and others are not, is called a state, and it is feasible for a single cam to have multiple states, determined by parallel rows of detents on longitudinal lines on the curved surface of the cylinder cam 611. The invention allows a single cam to control a number of microvalves in combination and to control the mixing of fluids in the microfluidic system. In various applications, each of the fluid storage vessels 436a-d contains a different chemical reagent, and the combination of cam-driven microvalves allows for the rapid and controlled mixture of selected reagents according to a state selected by rotating the cam 611.

Those of skill in the art will understand that, although the illustrated embodiment in FIGS. 11 and 12 includes four fluid storage vessels 436a-d, an embodiment of the apparatus could include fewer or more fluid storage vessels without altering the basic concept of the apparatus.

Those of skill in the art will recognize that the cylinder cam described above, in various embodiments, is adapted to be used with multifunction devices, including but not limited to distribution valves, switching valves, peristaltic pumps, and other devices. In other embodiments, two or more actuators work as a differential to produce a complex array of actuation states.

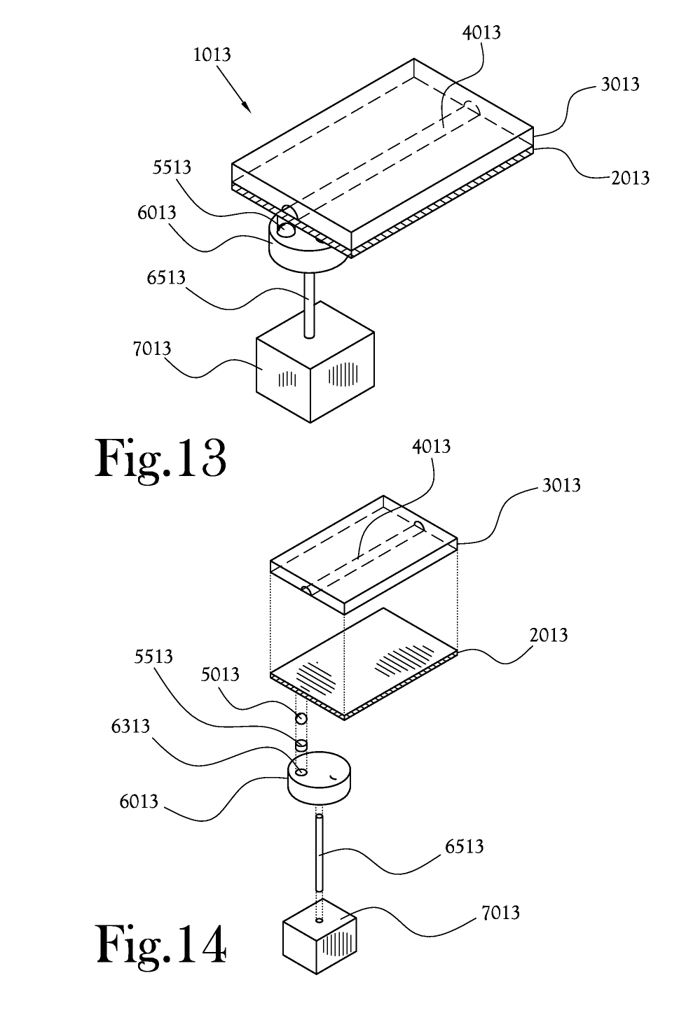

In the embodiments illustrated in FIGS. 2-12, the cam comprises a cylinder with detents on the curved surface of the cylinder and the cylinder's axis of rotation running approximately parallel to the plane of the elastomeric first layer. FIG. 13 shows one embodiment of the invention with an alternative style of cam. In this embodiment, the microvalve 1013 includes a cylinder-shaped cam 6013 in which the cylinder's central axis of rotation is approximately perpendicular to the plane of the first layer 2013. As is shown in the exploded view of FIG. 14, the cylinder-shaped cam 6013 has a flat, circular surface oriented toward the first layer 2013. This flat, circular surface of the cam 6013 includes a detent 6313. The microvalve 1013 also includes an actuator ball 5013, a guide tube 5513, a cam-driving axle 6513, and a PCM 7013. During operation, the PCM 7013 rotates the cam-driving axle 6513 to rotate the cam 6013 about the cam's central axis of rotation. As the cam 6013 rotates, the actuator ball 5013, which does not rotate with the cam 6013, moves into and out of the detent 6313 and therefore moves within the guide tube 5513 away from and towards the first layer 2013. When the actuator ball 5013 rests in the detent 6313, the actuator ball 5013 exerts minimal pressure on the first layer 2013, and thus the channel 4013 within the second layer 3013 remains open, the flow of fluid through the channel 4013 being unobstructed. When the cam 6013 rotates and moves the detent 6313 away from the actuator ball 5013, then the actuator ball 5013 moves out of the detent 6313, and the actuator ball 5013, pushed by the surface of the cam 6013, moves within the guide tube 5513 toward the first layer 2013, thereupon exerting deformative pressure on the first layer 2013 and pinching the microvalve 1013, thereby obstructing the flow of fluid through the channel 4013. The style of cam 6013 shown in FIGS. 13 and 14 is designated a “rotary-style” cam to distinguish it from the cylinder cams shown in FIGS. 2-12.

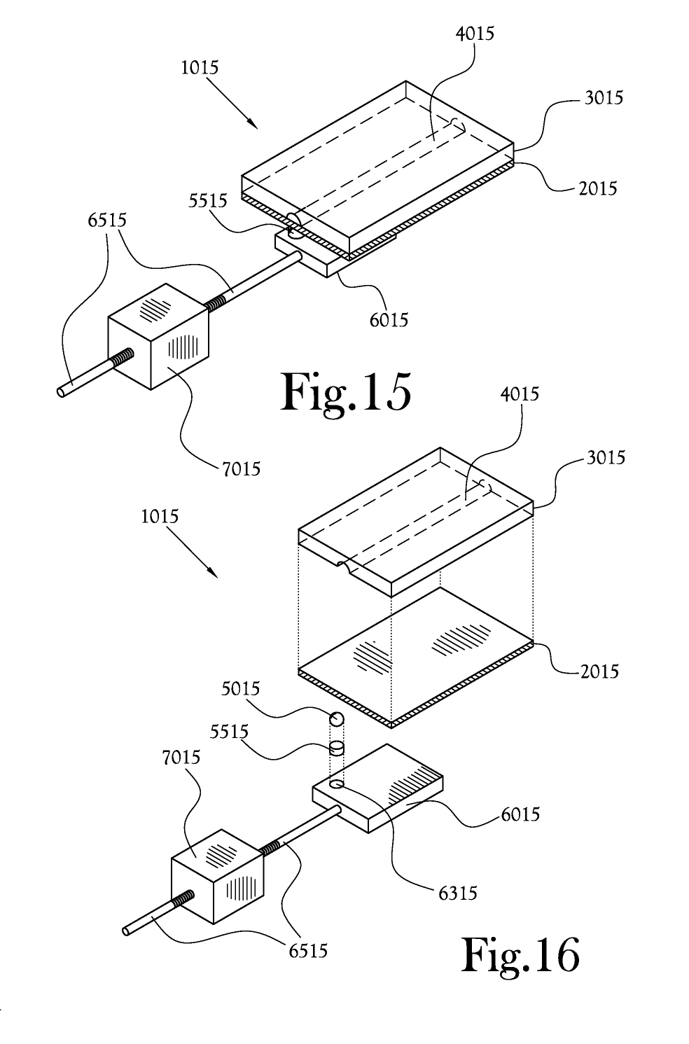

FIG. 15 shows one embodiment of the invention with an alternative style of cam. As is shown in the exploded view of the embodiment in FIG. 16, in this embodiment, the microvalve 1015 includes a flat, plate-shaped cam 6015 in which the surface of the plate oriented toward the first layer 2015 includes a detent 6315. The microvalve 1015 also includes an actuator ball 5015, a guide tube 5515, a cam-driving rod 6515, and a PCM 7015. During operation, the PCM 7015 moves the cam-driving rod 6515 to laterally move the cam 6015 through a range of positions on a line approximately parallel to the plane of the first layer 2015. As the cam 6015 moves, the actuator ball 5013, which does not move with the cam 6015, moves into and out of the detent 6315 and thereby moves within the guide tube 5515 away from and towards the first layer 2015. When the actuator ball 5015 rests in the detent 6315, the actuator ball 5015 exerts minimal pressure on the first layer 2015, and thus the channel 4015 within the second layer 3015 remains open, the flow of fluid through the channel 4015 being unobstructed. When the cam 6015 moves laterally and thereby moves the detent 6315 away from the actuator ball 5015, then the actuator ball 5015 moves out of the detent 6315, and the actuator ball 5015, pushed by the surface of the cam 6015, moves within the guide tube 5515 toward the first layer 2015, thereupon exerting deformative pressure on the first layer 2015 and pinching the microvalve 1015, thereby obstructing the flow of fluid through the channel 4013.

Those of skill in the art will recognize that both the rotary cam and the plate cam described above, in various embodiments, are equipped with multiple detents and adapted to operate with several actuator balls positioned to pinch different channels, as is done with the cylinder cam in FIG. 8 and FIG. 11, among other embodiments. Those of skill in the art will also recognize that, as with the cylinder cam, the rotary cam and the plate cam, in various embodiments, are adapted to be used with multifunction devices, including but not limited to distribution valves, switching valves, peristaltic pumps, and other devices.

In the illustrated embodiments in FIGS. 2-16, the cam features one or more detents adapted to allow an actuator ball to move away from the elastomeric first layer; when an actuator ball is not resting in one of the detents, it is positioned on an undetented portion of the cam surface and is pressing against the first layer, pinching the valve. However, in some embodiments a cam-driven microvalve according to the present invention includes a cam with one or more raised areas or bumps rather than detents. In these embodiments, when the actuator ball is resting on or against the unraised portion of the surface of the cam, the actuator ball does not exert deformative pressure on the first layer. As the cam moves and the bump or raised area moves into position so that the actuator ball now rests on or against the bump or raised area, the actuator ball exerts deformative pressure on the first layer. Additional modifications and embodiments will be readily apparent to those skilled in the art.

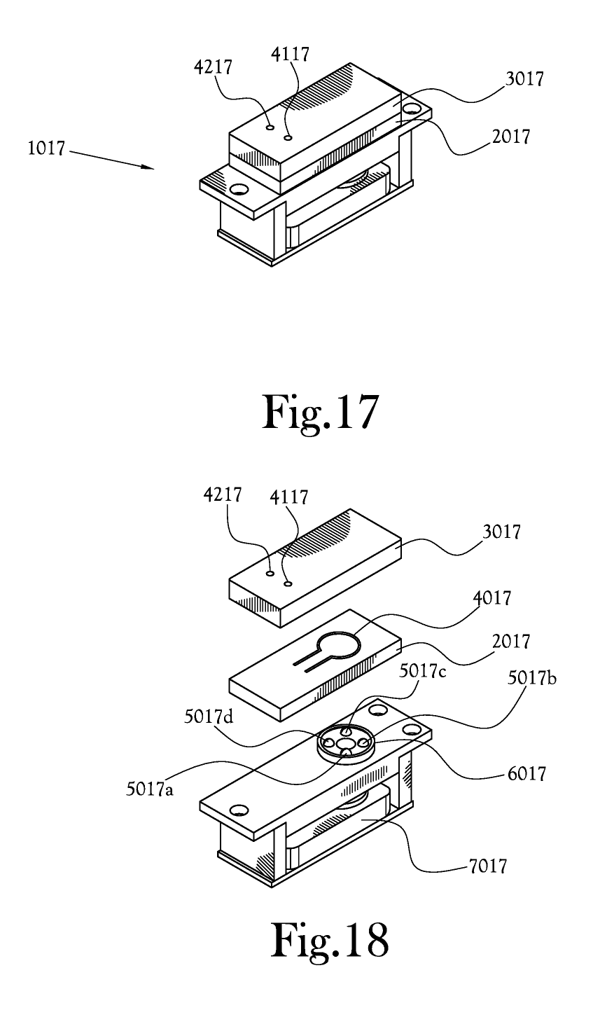

In some embodiments a cam-driven microvalve according to the present invention is included in a peristaltic micropump. FIG. 17 shows a perspective view of one embodiment of a cam-driven peristaltic micropump. As shown in FIG. 17 and in the exploded view of the same embodiment in FIG. 18, the device 1017 includes an elastomeric first layer 2017 and a second layer 3017 that cooperatively define a channel 4017, with fluid flowing into and out of the channel 4017 through an inlet 4117 and outlet 4217 in the second layer 3017. A rotary-style cam 6017, similar to the rotary-style cam shown in FIGS. 13 and 14, supports a plurality of actuator balls 5017a-d. (In the illustrated embodiment, four actuator balls are shown; other embodiments of the cam-driven peristaltic micropump have a lesser or greater number of actuator balls, although preferably the cam-driven peristaltic micropump includes a minimum of three actuator balls.) A PCM 7017 is positioned and adapted to control the rotary movement of the rotary-style cam 6017.

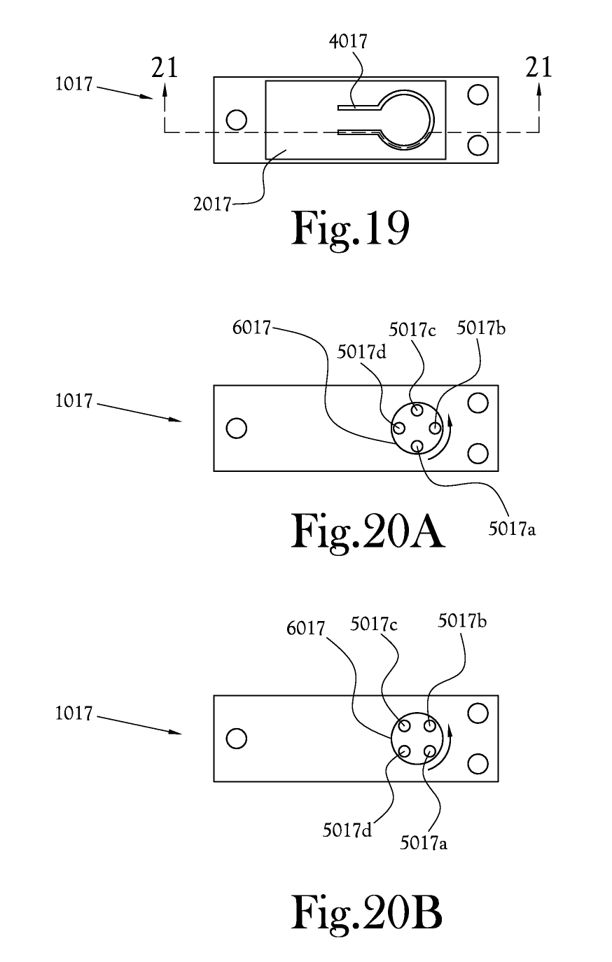

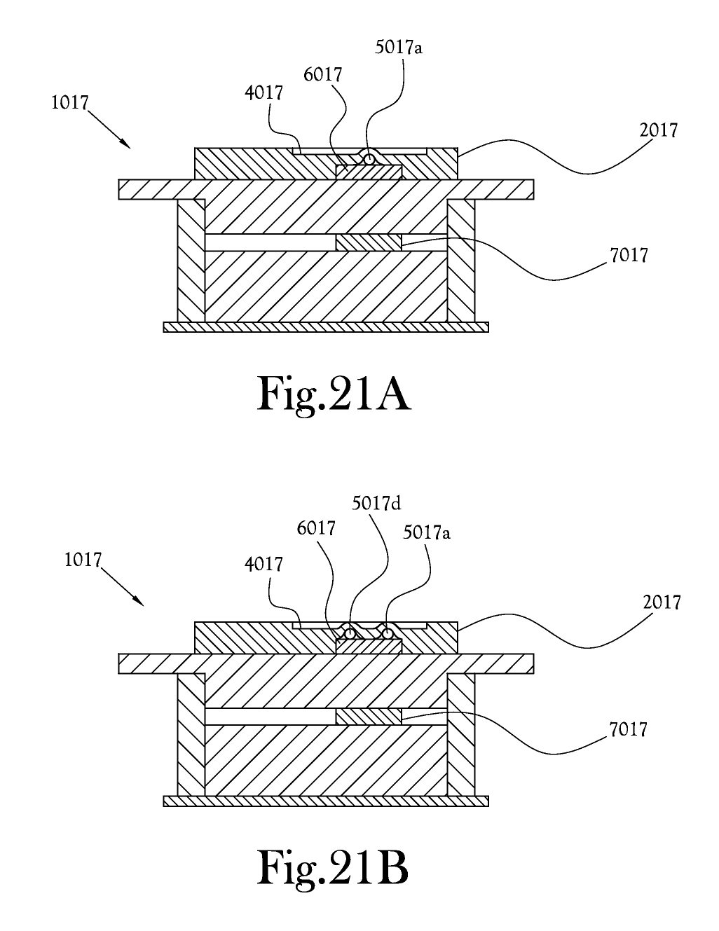

FIG. 19 shows a top-down view of the embodiment shown in FIGS. 17 and 18, with the second layer 3017 removed. FIGS. 20A and 20B likewise show a topdown view of the same embodiment as FIGS. 17-19, with the first layer and the second layer removed to better show the rotary-style cam 6017. As shown in these Figures and in the sectional views of FIGS. 21A and 21B, the cam 6017 moves the actuator balls 5017a-d in a pattern to move fluid through the channel 4017 in a chosen direction. For example, in FIGS. 20A and 21A, the cam 6017 is in a first state wherein three of the four actuator balls, 5017a-c, are pinching the channel 4017 at certain points along the course of the channel 4017. Then, as the cam 6017 rotates into a second state, shown in FIGS. 20B and 21B, the actuator balls 5017a-d are now pinching the channel 4017 at different “pinch points” along the course of the channel. As the cam 6017 continues to rotate, the actuator balls 5017a-d are continuously deforming the first layer 2017 at points along the course of the channel 4017; fluid caught within the channel 4017 between the rotating pinch points is driven in the direction of rotation as the cam 6017 rotates and the actuator balls 5017a-d continue their revolution.

The speed with which fluid moves through the pump 1017 is controlled by the speed with which the cam 6017 rotates. In alternative embodiments, a set of actuator balls are engaged and disengaged in sequence along the course of a channel to displace and drive fluid in the channel. Additional modifications and embodiments will be readily apparent to those skilled in the art.

While the present invention has been illustrated by description of several embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. A cam-driven microvalve for controlling the flow of fluids in a microfluidic system comprising
a first layer and a second layer cooperatively defining a channel, said first layer being fabricated from a elastomeric material,
an actuator adapted to press said first layer against said second layer in a substantially fluid-tight fit to substantially stop the flow of fluid through said channel,
a cam adapted to move said actuator,
a position-control mechanism adapted to move said cam between a first position and a second position, wherein when said cam is in said first position, said cam moves said actuator so that said actuator presses said first layer against said second layer in a substantially fluid-tight fit, and when said cam is in said second position, said cam moves said actuator so that said actuator does not press said first layer against said second layer in in a substantially fluid-tight fit.

2. The cam-driven microvalve of claim 1 wherein said cam includes a cylinder adapted to rotate about the axis of said cylinder, said cylinder including a detent adapted to allow said actuator to move relative to said first layer.

3. The cam-driven microvalve of claim 1 wherein said cam includes a plate adapted to move laterally with respect to said first layer, said plate including a detent adapted to allow said actuator to move relative to said first layer.

4. The cam-driven microvalve of claim 1 wherein said actuator includes an actuator ball.

5. The cam-driven microvalve of claim 4 wherein said cam includes a cylinder adapted to rotate about the axis of said cylinder, said cylinder including a detent adapted to allow said actuator ball to move relative to said first layer.

6. The cam-driven microvalve of claim 4 wherein said cam includes a plate adapted to move laterally with respect to said first layer, said plate including a detent adapted to allow said actuator ball to move relative to said first layer.

7. The cam-driven microvalve of claim 4 wherein said actuator includes multiple actuator balls.

8. The cam-driven microvalve of claim 7 wherein said actuator balls are adapted to drive fluid through said channel.

9. An eccentrically actuated device for controlling the flow of fluids in a microfluidic system comprising
a first layer fabricated from an elastomeric material,
a second layer,
a channel positioned between said first layer and said second layer,
an actuator adapted to deform said first layer through pressure,
a cam adapted to move said actuator, said cam possessing a first position and a second position, whereby when said cam is in said first position, said actuator does not exert deformative pressure on said first layer, and when said cam is in said second position, said actuator deforms said first layer,
a position-control mechanism adapted to adjust said cam between said first state and said second state,
whereby when said position-control mechanism adjusts said cam so that said cam is in said second state, said actuator deforms said first layer so that said first layer and said second layer meet within said channel, thereby obstructing the flow of fluid through said channel.

10. The device of claim 8 further comprising a plurality of actuators, said actuators being adapted to drive fluid through said channel.

11. An apparatus for controlling the flow of fluids in a microfluidic system comprising
a plurality of microvalves, each said microvalve including a first layer fabricated from an elastomeric material, a second layer, a channel positioned between said first layer and said second layer, and an actuator ball adapted to deform said first layer through pressure,
a cylinder cam adapted to exert pressure on said actuator balls, thereby forcing said actuator balls to deform said first layers, whereby first layer and said second layer meet within said channel to obstruct the flow of fluid through said channel, said cylinder cam including a plurality of detents, each said detent positioned to be positioned under one of said actuator balls when said cam is rotated into a particular position, whereby when a said actuator ball rests in a said detent, said actuator ball does not exert deformative pressure on said first layer, and
a mechanism for controlling the rotation of said cylinder cam.

12. The apparatus of claim 9 further comprising a plurality of fluid storage vessels, each said fluid storage vessel being in fluid communication with one of said microvalves, said microvalve adapted to control the flow of fluid from said fluid storage vessel.
